(19) United States
(12) Patent Application Publication
(10) Pub. No.: US 2011/0252793 A1
(43) Pub. Date: Oct. 20, 2011

(54) DEVICE FOR TURBOCHARGING AN INTERNAL COMBUSTION ENGINE, VEHICLE, AND METHOD FOR TURBOCHARGING AN INTERNAL COMBUSTION ENGINE

(75) Inventors: Thomas HILD, Mainz (DE); Michael CREMER, Muenster-Ebernberg (DE)

(73) Assignee: GM GLOBAL TECHNOLOGY OPERATIONS LLC, Detroit, MI (US)

(21) Appl. No.: 13/088,108

(22) Filed: Apr. 15, 2011

(30) Foreign Application Priority Data
Apr. 17, 2010 (DE) 102010015295.1

(51) Int. Cl. F02B 37/00; F01N 3/10

(52) U.S. Cl. 60/605.1

(57) ABSTRACT

A device for turbocharging an internal combustion engine that includes, but is not limited to a compressor, which is situated in a fresh air line, a turbine, which is situated in an exhaust line and drives the compressor, and a catalytic converter, which is situated after the turbine in the intake line in the flow direction of the exhaust gas. Furthermore, the device includes, but is not limited to a cooling air line, which is diverted from the fresh air line between the compressor and the internal combustion engine, the cooling air line discharging into the exhaust line between the internal combustion engine and the catalytic converter and an expansion valve being connected in the cooling air line.

### CROSS-REFERENCE TO RELATED APPLICATION

This application claims priority to German Patent Application No. 102010015295.1, filed Apr. 17, 2010, which is incorporated herein by reference in its entirety.

### TECHNICAL FIELD

The technical field relates to a device for turbocharging an internal combustion engine having a turbocharger. Furthermore, it relates to a vehicle having such a device and a method for turbocharging an internal combustion engine.

### BACKGROUND

Temperature-sensitive components such as the turbine of the turbocharger or the catalytic converter cannot be subjected to arbitrarily high exhaust gas temperatures in operation. The reduction of the exhaust gas temperature is often accompanied by fuel-wasting operating modes of the internal combustion engine and/or cooling methods which are complex in another way. An efficiency increase of the combustion process is therefore often limited by the necessity of maintaining temperature limiting values.

Reducing the temperature in the exhaust line in that a cooled secondary gas stream is fed in is known from DE 10 2007 058 964 A1. The secondary gas stream is taken from the fresh air line or from the exhaust line, cooled, and compressed and conveyed using a compressor. It is thus possible to feed in cool gas on demand and therefore to regulate the temperature in the exhaust line. However, the device is comparatively complex and requires the installation and operation of a further turbine and a further compressor in particular.

In view of the foregoing, at least one object is therefore to specify a device for turbocharging an internal combustion engine, which allows an efficiency increase of the combustion process and simultaneously does not require large technical or energetic expenditure in installation or operation. In addition, it is at least a further object to specify an efficient method for turbocharging an internal combustion engine. Furthermore, other objects, desirable features and characteristics will become apparent from the subsequent summary and detailed description, and the appended claims, taken in conjunction with the accompanying drawings and this background.

### SUMMARY

A device is provided for turbocharging an internal combustion engine that comprises a compressor, which is situated in a fresh air line, a turbine, which is situated in an exhaust line and drives the compressor, and an exhaust gas catalytic converter, which is situated in the exhaust line in the flow direction of the exhaust gas after the turbine. Furthermore, it comprises a cooling air line which branches off from the fresh air line between the compressor and the internal combustion engine, the cooling air line discharging into the exhaust line between the internal combustion engine and the catalytic converter and an expansion valve being connected in the cooling air line.

According to an embodiment, at least in many load states of the internal combustion engine, there is naturally a pressure differential between the intake and the outlet of the internal combustion engine and therefore between the fresh air line after the compressor and the exhaust line before or after the turbine. This pressure differential can be used in a targeted manner for exhaust gas cooling, in that a partial stream is diverted from the fresh air line as cooling air and is essentially adiabatically relaxed via an expansion valve. The cooling air, which is cooled by the relaxation to the pressure level in the exhaust line, is fed into the exhaust line and therefore cools the exhaust gas.

It is necessary to first compress the cooling air for this purpose. However, this is performed in any case, the pressure differential to be used resulting in specific load states. The device therefore makes targeted use of this pressure differential and exploits a previously unused potential.

It only requires the provision of the cooling air line with an expansion valve. It therefore has the advantage of allowing exhaust gas cooling in a very technically simple and cost-effective way. Higher exhaust gas temperatures and therefore efficient, fuel-saving combustion processes are possible in the area of the internal combustion engine, without temperature-sensitive components such as the turbine and the catalytic converter being excessively strained.

According to one embodiment, the cooling air line discharges into the exhaust line before the turbine in the flow direction of the exhaust gas. This embodiment has the advantage that not only the catalytic converter, but rather also the temperature-sensitive turbine can be cooled.

According to an alternative embodiment, the cooling air line discharges into the exhaust line between the turbine and the catalytic converter. In this embodiment, the turbine is accordingly not cooled by the cooling air, but rather only the catalytic converter. This embodiment has the advantage that the pressure differential which is usable for the expansion and therefore the cooling of the cooling air is greater than if the cooling air is fed in before the turbine. Therefore, if cooling of the turbine can be dispensed with; stronger cooling of the catalytic converter can be achieved using this embodiment.

It is also conceivable to combine both embodiments with one another and to provide a first discharge of the cooling air line before the turbine and a second discharge between the turbine and the catalytic converter. In this case, a three-way valve can be provided in the cooling air line, which controls the cooling air stream appropriately. Depending on the load state of the internal combustion engine and depending on the cooling demand, the temperature of the exhaust gas can already be reduced before the turbine or also only before the catalytic converter.

This embodiment has the advantage that a selection can be made between a uniform relief of turbine and catalytic converter and a particularly good relief of only the catalytic converter and therefore the instantaneous cooling air demand can be reacted to particularly flexibly. The expansion valve can be implemented as controllable and can therefore allow regulation of the cooling.

The cooling air line is advantageously implemented in such a way that a controllable cooling air quantity, for example, in the magnitude of approximately 5-10% of the volume of the fresh air line, is diverted from the fresh air line. With such a quantity of cooling air, a sufficient cooling effect can be achieved without disadvantageously influencing the combustion process.

According to one embodiment, the geometry of the turbine is adjustable in such a way that a predefined pressure differential is settable between the fresh air line and the exhaust line. In particular, the flow cross-section can be varied by opening and closing openings between the blades and the pressure in the exhaust line can therefore be regulated. The pressure differential between the fresh air line and the exhaust line is understood as the pressure differential between the respective discharges of the cooling air line.

The device for turbocharging an internal combustion engine can be used advantageously in particular in vehicles having gasoline or diesel engines.

According to an embodiment, a method for turbocharging an internal combustion engine is provided, fresh air being supplied to the internal combustion engine via a compressor situated in a fresh air line and exhaust gas being exhausted via an exhaust line having a turbine, which drives the compressor. Between the compressor and the internal combustion engine, cooling air is removed from the fresh air line, expanded, and fed into the exhaust line between the internal combustion engine and a catalytic converter. The cooling air can be fed into the exhaust line before the turbine or between the turbine and the catalytic converter in the flow direction of the exhaust gas.

According to an embodiment, the expansion of the cooling air is performed essentially adiabatically. An essentially adiabatic expansion is understood as an expansion in which the essential component of thermal energy withdrawn from the cooling air is used for expansion and only negligible quantities of heat are exchanged with the surroundings.

According to an embodiment, a predefined pressure differential can be set between the fresh air line and the exhaust line by an adjustment of the geometry of the turbine. A controllable cooling air quantity is advantageously diverted from the fresh air line as cooling air.

The method has the advantage that it allows cooling of the exhaust gas in the area of the turbine and/or the catalytic converter in a particularly simple way. The cooling is only usable in the operating states in which a pressure differential is available between the fresh air line and the exhaust line, and also is only controllable in specific limits, but the cooling only requires very little technical effort, since hardly any additional fixtures are necessary.

Complex heat exchangers or conveyor units for the cooling air stream can be dispensed with. The method therefore allows limited, but very efficient cooling of the exhaust gas. It can advantageously be supplemented using further, known methods for exhaust gas cooling, one or more methods also being able to be used depending on the load state.

### BRIEF DESCRIPTION OF THE DRAWINGS

The present invention will hereinafter be described in conjunction with the following drawing figures, wherein like numerals denote like elements, and:

FIG. 1 is schematically shows a device for turbocharging an internal combustion engine according to a first embodiment; and

FIG. 2 is schematically shows a device for turbocharging an internal combustion engine according to a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The device 1 for turbocharging the internal combustion engine 2 comprises a turbocharger 3 having a compressor 4 and a turbine 5, which drives the compressor 4 via the shared shaft 6. The compressor 4 is connected in the fresh air line 7, which leads from an air inlet 10 to the internal combustion engine 2. The turbine 5 is connected in the exhaust line 8, which leads from the internal combustion engine 2 to an air outlet 11.

The branch 15 of a cooling air line 12 is situated between the compressor 4 and the internal combustion engine 2 and therefore after the compressor 4 in the flow direction indicated by the arrows 14. The discharge 16 of the cooling air line 12 is situated between the internal combustion engine 2 and the turbine and therefore before the turbine 5 in the flow direction indicated by the arrows 14. The cooling air line 12 has a controllable expansion valve 13. In operation of the internal combustion engine, fresh air is conveyed and compressed by the compressor 4, so that a comparatively higher pressure p1 results in the area of the branch 15 in the fresh air line 7.

In contrast, in specific load states of the internal combustion engine 2, a comparatively lower pressure p2 results in the area of the discharge 16 into the exhaust line 8. This pressure differential Δp=p1−p2 particularly occurs in any case at speeds below approximately 3000 RPM. A positive differential can also be ensured on the compressor side, however, in that a regulation of the cooling air quantity is performed over the entire engine speed range.

The pressure differential Δp is used to relax cooling air essentially adiabatically via the controllable expansion valve 13 and therefore to cool it. The cooling air cooled in this way is fed into the exhaust line 8 in the area of the discharge 16 and causes a reduction of the exhaust gas temperature. The components, in particular the blades, of the turbine 5 and the catalytic converter 9 are therefore not excessively thermally loaded even if high combustion temperatures are implemented in the internal combustion engine 2 because of efficiency considerations.

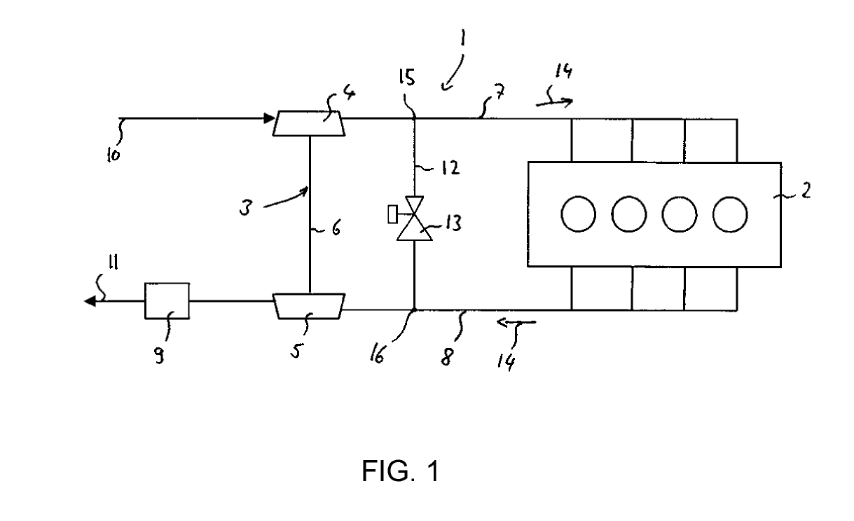

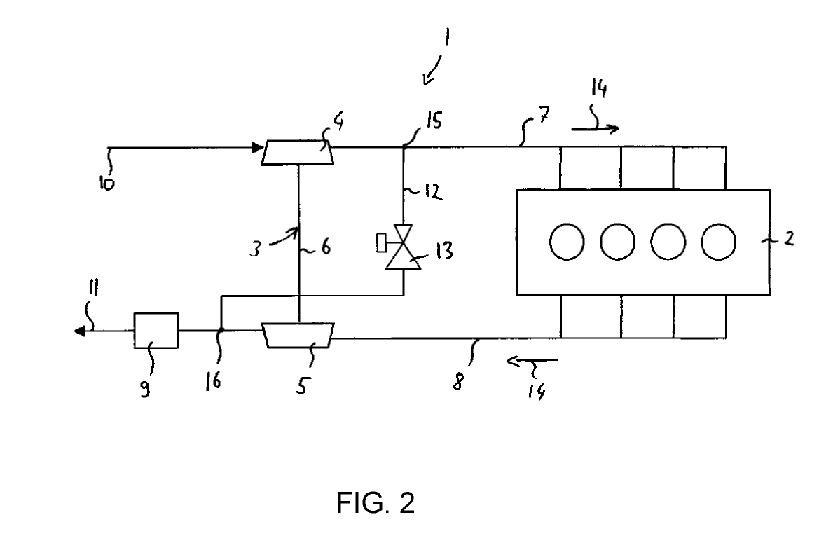

FIG. 2 shows a device 1 for turbocharging an internal combustion engine 2 according to a second embodiment. This embodiment differs from the first embodiment shown in FIG. 1 in that the discharge 16 of the cooling air line 12 into the exhaust line 8 is only situated after the turbine 5, but before the catalytic converter 9, in the flow direction indicated by the arrows 14.

According to the second embodiment, the cooling air is thus first fed into the exhaust line after the turbine 5, so that only the catalytic converter 9, but not the turbine 5, is cooled by the cooling air. In this second embodiment, a pressure p3 results in the area of the discharge 16, which is typically less than p2. The pressure differential Δp=p1−p3 which is usable for the expansion and therefore for the cooling is thus greater in the device 1 according to the second embodiment than in the device 1 according to the first embodiment. The cooling air in the area of the discharge 16 therefore has a lower temperature than in the first embodiment. Using the device 1 according to the second embodiment, it is possible to achieve particularly good cooling of the catalytic converter 9 by dispensing with cooling the turbine 5.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A device for turbocharging an internal combustion engine, comprising:
an exhaust line;
a fresh air line;
a compressor in the fresh air line;
a turbine in the exhaust line and configured to drive the compressor;
a catalytic converter situated in the exhaust line after the turbine in a flow direction of an exhaust gas;
a cooling air line diverted from the fresh air line between the compressor and the internal combustion engine, the cooling air line configured to discharge into the exhaust line between the internal combustion engine and the catalytic converter; and
an expansion valve connected in the cooling air line.

2. The device according to claim 1, wherein the cooling air line is configured to discharge into the exhaust line before the turbine in the flow direction of the exhaust gas.

3. The device according to claim 1, wherein the cooling air line is configured to discharge into the exhaust line between the turbine and the catalytic converter.

4. The device according to claim 1, wherein the cooling air line comprises:
a first branch configured to discharge into the exhaust line before the turbine; and
a second branch configured to discharge into the exhaust line between the turbine and the catalytic converter.

5. The device according to claim 1, wherein the expansion valve is a controllable expansion valve.

6. The device according to claim 1, wherein the cooling air line is configured such that a controllable cooling air quantity is diverted from the fresh air line.

7. The device according to claim 1, wherein a geometry of the turbine is configured such that a predefined pressure differential is settable between the fresh air line and the exhaust line.

8. A method for turbocharging an internal combustion engine, comprising:
supplying fresh air via a compressor situated in a fresh air line;
emitting exhaust gas an exhaust line having a turbine;
driving the compressor with the turbine;
removing cooling air from the fresh air line between the compressor and the internal combustion engine that is expanded, and fed into the exhaust line between the internal combustion engine and a catalytic converter.

9. The method according to claim 8, wherein the cooling air is fed into the exhaust line before the turbine in a flow direction of an exhaust gas.

10. The method according to claim 8, wherein the cooling air is fed into the exhaust line between the turbine and the catalytic converter.

11. The method according to claim 8, wherein expanding of the cooling air occurs essentially adiabatically.

12. The method according to claim 8, further comprising setting a predefined pressure differential between the fresh air line and the exhaust line by adjusting a geometry of the turbine.

13. The method according to claim 8, further comprising diverting a controllable cooling air quantity from the fresh air line as the cooling air.
